(19) United States
(12) Patent Application Publication
(10) Pub. No.: US 2014/0001114 A1
(43) Pub. Date: Jan. 2, 2014

(54) Fluid Filters

(71) Applicants: Yu Hatori, Meguro-Ku (JP); Akira Kamiya, Sagamihara-Shi (JP); Shigeo Daito, Yokohama-shi (JP); Therdsak Leokprasirtkul, Setagaya-ku (JP)

(72) Inventors: Yu Hatori, Meguro-Ku (JP); Akira Kamiya, Sagamihara-Shi (JP); Shigeo Daito, Yokohama-shi (JP); Therdsak Leokprasirtkul, Setagaya-ku (JP)

(21) Appl. No.: 13/539,495

(22) Filed: Jul. 2, 2012

(51) Int. Cl. B01D 39/00

(52) U.S. Cl. 210/483

(57) ABSTRACT

An apparatus disclosed herein includes a pliable filter and a brace coupled to the filter. The example apparatus further includes a first portion of a housing coupled to a second portion of the housing to hold the filter across an inlet of a first fluid flow passageway, which is in fluid communication with a second fluid flow passageway via the inlet. A seal is disposed between the brace and the housing and surrounds the inlet.

### BACKGROUND OF THE DISCLOSURE

Generally, fluid from a subterranean formation is a mixture of water, oil, gases, and/or particulates. Sampling the fluid involves positioning a downhole tool in a borehole adjacent a formation, sealing an interval of the borehole along the downhole tool and adjacent the formation and extracting the fluid from the formation. The fluid may then be evaluated and/or analyzed using one or more sensors disposed on the downhole tool.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

An example apparatus disclosed herein includes a filter including a pliable sheet and a support coupled to the sheet. The example apparatus also includes a first portion of a housing coupled to a second portion of the housing to hold the filter over a first fluid flow passageway and adjacent a second fluid flow passageway such that fluid is to flow along a surface of the filter as the fluid flows through the second fluid flow passageway. The example apparatus further includes a seal positioned between the support and the housing to provide a fluid seal surrounding the one or more fluid flow paths of the filter.

Another example apparatus disclosed herein includes a pliable filter and a brace coupled to the filter. The example apparatus further includes a housing holding the filter across an inlet of a first fluid flow passageway, which is in fluid communication with a second fluid flow passageway via the inlet. A seal is disposed between the brace and the housing and surrounds the inlet.

Another example apparatus disclosed herein includes means for supporting coupled to means for filtering. The example apparatus further includes first means for holding defining a first fluid flow passageway. The first means for holding is coupled to second means for holding to hold the means for filtering across an inlet of the first fluid flow passageway, which is in fluid communication with a second fluid flow passageway via the inlet. The example apparatus also includes means for sealing disposed between the means for supporting and the first means for holding and surrounding the inlet.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates an example system in which embodiments of fluid filters can be implemented;

FIG. 2 illustrates another example system in which embodiments of fluid filters can be implemented;

FIG. 3 illustrates another example system in which embodiments of fluid filters can be implemented;

FIG. 4 illustrates various components of an example device that can implement embodiments of fluid filters;

FIG. 5 illustrates various components of the example device of FIG. 4 that can implement embodiments of fluid filters;

FIG. 6 illustrates various components of the example device of FIG. 4 that can implement embodiments of fluid filters;

FIG. 7 illustrates various components of the example device of FIG. 4 that can implement embodiments of fluid filters;

FIG. 8 illustrates various components of the example device of FIG. 4 that can implement embodiments of fluid filters;

FIG. 9 illustrates various components of an example device that can implement embodiments of fluid filters;

FIG. 10 illustrates various components of an example device that can implement embodiments of fluid filters;

FIG. 11 illustrates various components of an example device that can implement embodiments of fluid filters;

FIG. 12 illustrates various components of an example device that can implement embodiments of fluid filters;

FIG. 13 illustrates various components of an example device that can implement embodiments of fluid filters; and

FIG. 14 illustrates various components of an example device that can implement embodiments of fluid filters.

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features such that the first and second features may not be in direct contact.

One or more aspects of the present disclosure relate to fluid filters. Formation fluid may be a mixture of liquids, gases, and/or particulates. Example apparatus disclosed herein may be used to separate a fluid from the formation fluid. Example apparatus disclosed herein may include a filter including a pliable sheet and a support coupled to the sheet. The support may define one or more fluid flow paths of the filter. A first portion of a housing is coupled to a second portion of the housing to hold the filter over a first fluid flow passageway adjacent a second fluid flow passageway such that the formation fluid is to flow along a surface of the filter as the formation fluid flows through the second fluid flow passageway. The example apparatus may further include a seal positioned between the support and the housing to provide a fluid seal surrounding the one or more fluid flow paths of the filter. In some instances, the first portion of the housing holds the filter via a perforated partition to substantially prevent deformation of the sheet where the partition contacts the sheet. The first fluid flow passageway may be in fluid communication with a sensor, and the second fluid flow passageway may be in fluid communication with a flowline of a downhole tool.

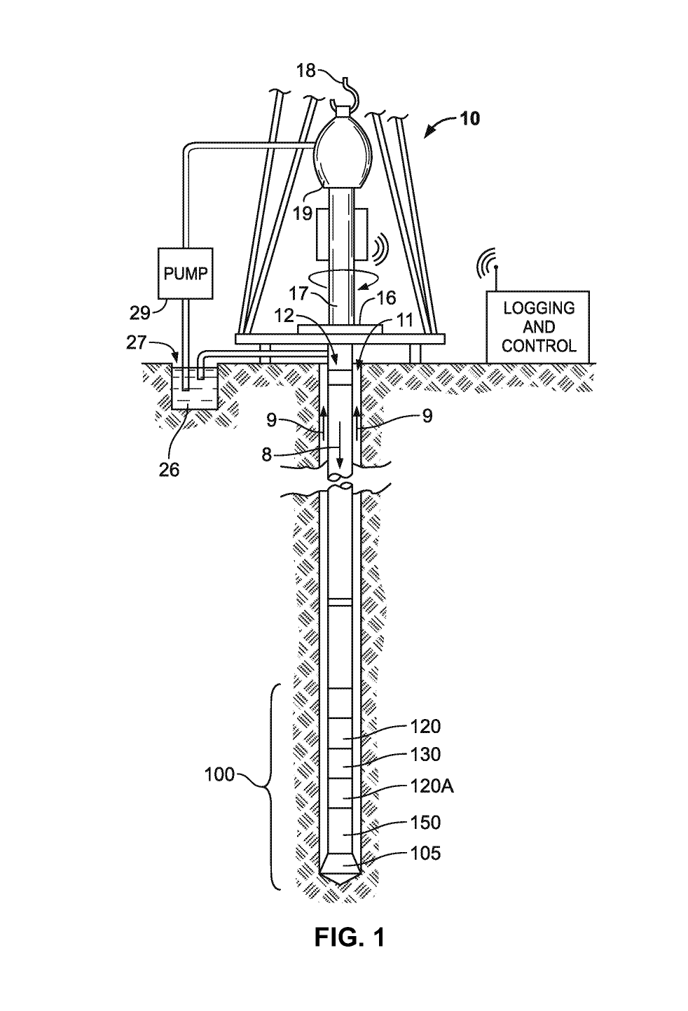

FIG. 1 illustrates a wellsite system in which the present invention can be employed. The wellsite can be onshore or offshore. In this example system, a borehole 11 is formed in subsurface formations by rotary drilling in a manner that is well known. Embodiments can also use directional drilling, as will be described hereinafter.

A drill string 12 is suspended within the borehole 11 and has a bottom hole assembly 100, which includes a drill bit 105 at its lower end. The surface system includes platform and derrick assembly 10 positioned over the borehole 11. The assembly 10 includes a rotary table 16, kelly 17, hook 18 and rotary swivel 19. The drill string 12 is rotated by the rotary table 16, energized by means not shown, which engages the kelly 17 at the upper end of the drill string 12. The drill string 12 is suspended from the hook 18, attached to a traveling block (also not shown), through the kelly 17 and the rotary swivel 19, which permits rotation of the drill string 12 relative to the hook 18. As is well known, a top drive system could be used.

In the example of this embodiment, the surface system further includes drilling fluid or mud 26 stored in a pit 27 formed at the well site. A pump 29 delivers the drilling fluid 26 to the interior of the drill string 12 via a port in the swivel 19, causing the drilling fluid 26 to flow downwardly through the drill string 12 as indicated by the directional arrow 8. The drilling fluid 26 exits the drill string 12 via ports in the drill bit 105, and then circulates upwardly through the annulus region between the outside of the drill string 12 and the wall of the borehole, as indicated by the directional arrows 9. In this well known manner, the drilling fluid 26 lubricates the drill bit 105 and carries formation cuttings up to the surface as it is returned to the pit 27 for recirculation.

The bottom hole assembly 100 of the illustrated embodiment includes a logging-while-drilling (LWD) module 120, a measuring-while-drilling (MWD) module 130, a roto-steerable system and motor 150, and the drill bit 105.

The LWD module 120 is housed in a special type of drill collar, as is known in the art, and can contain one or a plurality of known types of logging tools. It will also be understood that more than one LWD and/or MWD module can be employed, e.g. as represented at 120A. References throughout to a module at the position of 120 can mean a module at the position of 120A as well. The LWD module 120 includes capabilities for measuring, processing, and storing information, as well as for communicating with the surface equipment. In the present embodiment, the LWD module 120 includes a fluid sampling device.

The MWD module 130 is also housed in a special type of drill collar, as is known in the art, and can contain one or more devices for measuring characteristics of the drill string 12 and the drill bit 105. The MWD module 130 further includes an apparatus (not shown) for generating electrical power to the downhole system. This may include a mud turbine generator powered by the flow of the drilling fluid, it being understood that other power and/or battery systems may be employed. In the present embodiment, the MWD module 130 includes one or more of the following types of measuring devices: a weight-on-bit measuring device, a torque measuring device, a vibration measuring device, a shock measuring device, a stick slip measuring device, a direction measuring device, and an inclination measuring device.

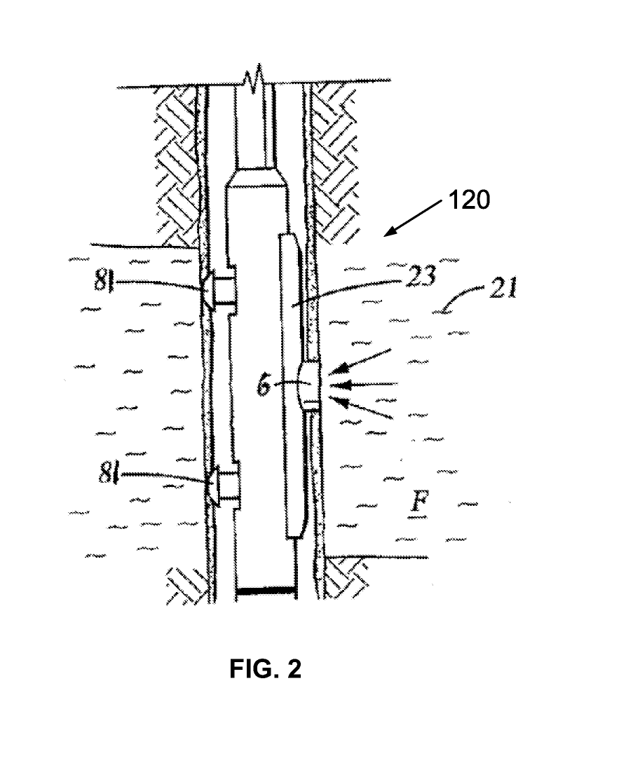

FIG. 2 is a simplified diagram of a sampling-while-drilling logging device of a type described in U.S. Pat. No. 7,114,562, incorporated herein by reference in its entirety, utilized as the LWD tool 120 or part of an LWD tool suite 120A. The LWD tool 120 is provided with a probe 6 for establishing fluid communication with a formation F and drawing fluid 21 into the tool, as indicated by the arrows. The probe 6 may be positioned in a stabilizer blade 23 of the LWD tool and extended therefrom to engage the borehole wall. The stabilizer blade 23 comprises one or more blades that are in contact with the borehole wall. Fluid drawn into the downhole tool using the probe 6 may be measured to determine, for example, pretest and/or pressure parameters. Additionally, the LWD tool 120 may be provided with devices, such as sample chambers, for collecting fluid samples for retrieval at the surface. Backup pistons 81 may also be provided to assist in applying force to push the drilling tool and/or the probe 6 against the borehole wall.

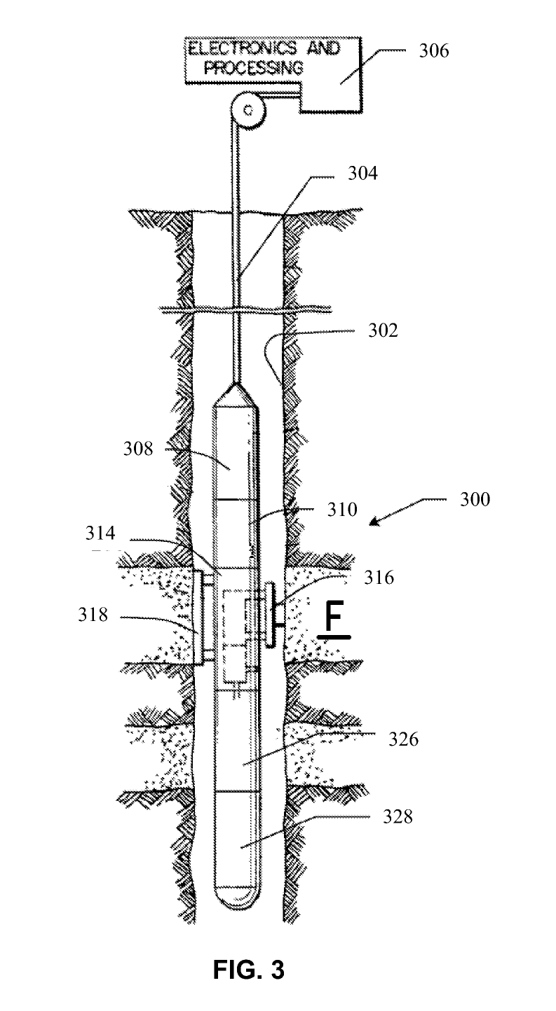

FIG. 3 depicts an example wireline tool 300 that may be another environment in which aspects of the present disclosure may be implemented. The example wireline tool 300 is suspended in a wellbore 302 from the lower end of a multiconductor cable 304 that is spooled on a winch (not shown) at the Earth's surface. At the surface, the cable 304 is communicatively coupled to an electronics and processing system 306. The example wireline tool 300 includes an elongated body 308 that includes a formation tester 314 having a selectively extendable probe assembly 316 and a selectively extendable tool anchoring member 318 that are arranged on opposite sides of the elongated body 308. Additional components (e.g., 310) may also be included in the tool 300.

The extendable probe assembly 316 may be configured to selectively seal off or isolate selected portions of the wall of the wellbore 302 to fluidly couple to an adjacent formation F and/or to draw fluid samples from the formation F. Accordingly, the extendable probe assembly 316 may be provided with a probe having an embedded plate, as described above. The formation fluid may be expelled through a port (not shown) or it may be sent to one or more fluid collecting chambers 326 and 328. In the illustrated example, the electronics and processing system 306 and/or a downhole control system are configured to control the extendable probe assembly 316 and/or the drawing of a fluid sample from the formation F.

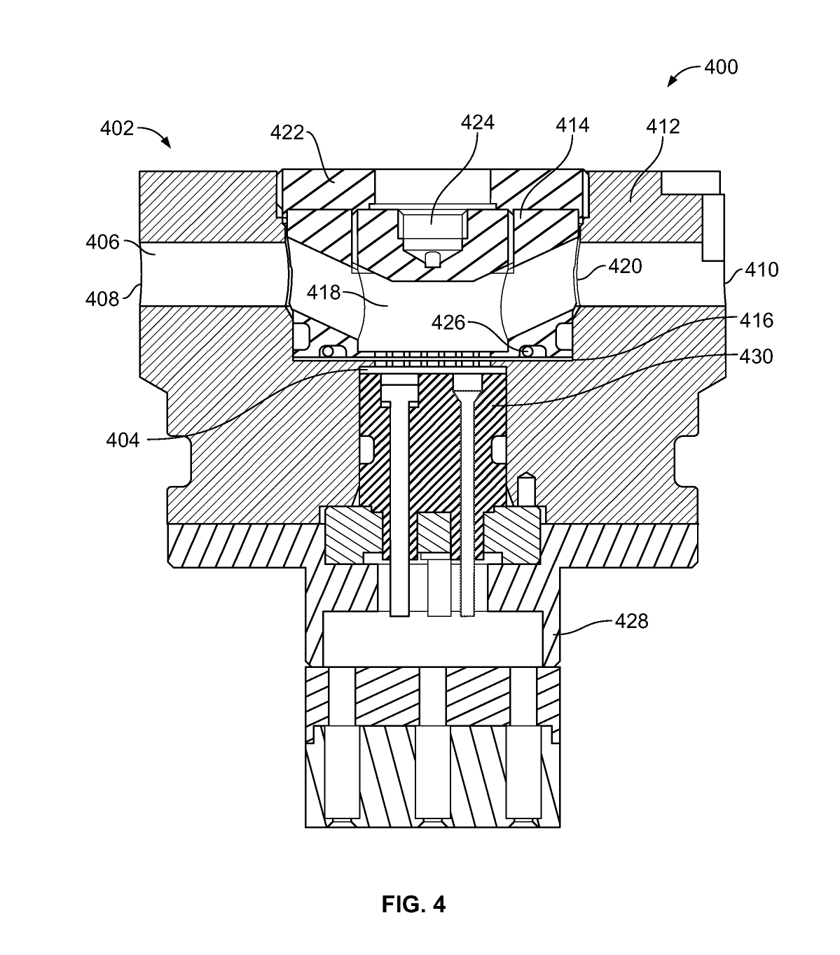

FIG. 4 illustrates an example apparatus 400 disclosed herein, which may be used to separate a fluid from a fluid mixture (e.g., formation fluid, which is a mixture of liquids, gases, and/or particulates). The example apparatus 400 includes a housing 402 defining a first fluid flow passageway 404 and a second fluid flow passageway 406. In the illustrated example, the first fluid flow passageway 404 is in fluid communication with the second fluid flow passageway 406. In some examples, the second fluid flow passageway 406 is in fluid communication with a flowline of a downhole tool (e.g., the downhole tool of FIG. 1, 2 or 3) via an inlet 408 and an outlet 410 of a first portion 412 of the housing 402. In some such examples, the flows mixture through the example apparatus 400 via the second fluid flow passageway 406.

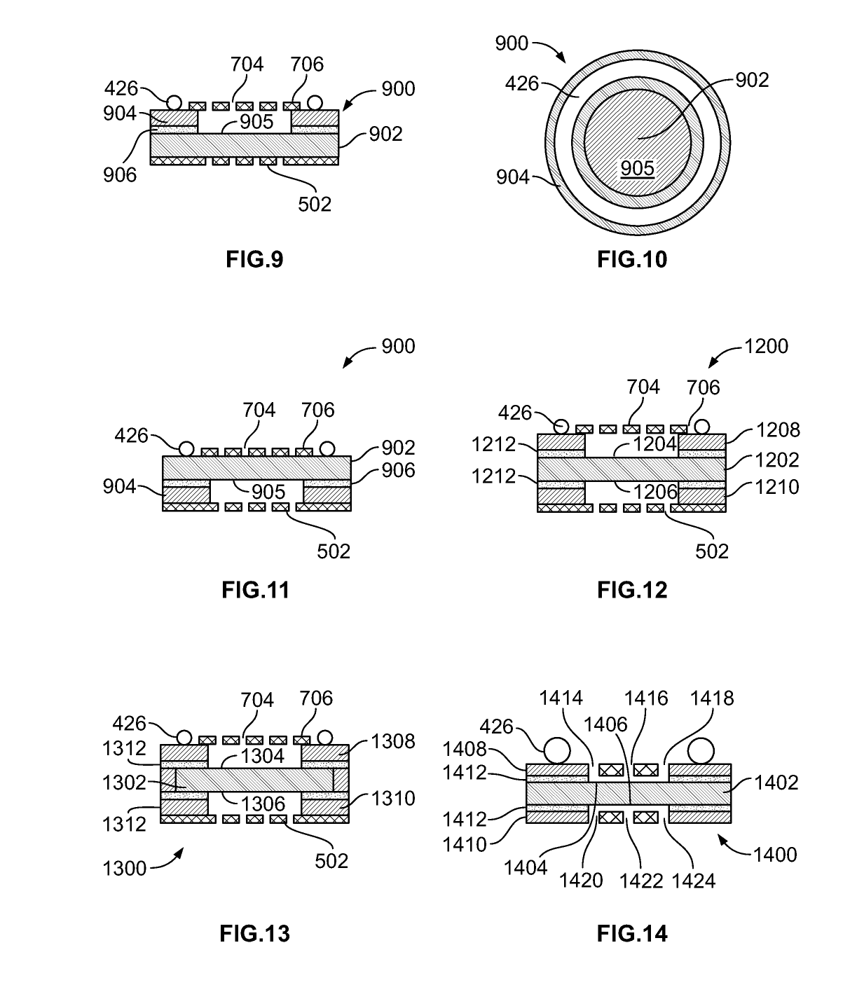

The first portion 412 of the housing 402 is coupled to a second portion 414 of the housing 402 to hold a filter 416 (e.g., a polytetrafluoroethylene (PTFE) membrane, a polydimethylsiloxane (PDMS) membrane, and/or any other suitable filter) over the first fluid flow passageway 404 and adjacent the second fluid flow passageway 406 such that the fluid mixture flows along a surface (FIGS. 9-14) of the filter 416 as the fluid mixture flows through the second fluid flow passageway 406. As a result, a portion the fluid mixture (e.g., oil) may pass through the filter 416 and flow into the first fluid flow passageway 404. In the illustrated example, the filter 416 is positioned adjacent a section 418 of the second fluid flow passageway 406 that extends in a direction that is substantially perpendicular to the first fluid flow passageway 404. In other examples, the filter 416 is positioned adjacent other sections of the second fluid flow passageway 406.

In the illustrated example, the second portion 414 of the housing 402 is disposed in a bore or cavity 420 of the first portion 412 and coupled to the first portion 412 via a cap 422 and a plug 424. In some examples, a seal 426 (e.g., an o-ring) is disposed between the filter 416 and the second portion 414 of the housing 402 to provide a fluid seal surrounding the first fluid flow passageway 404.

In the illustrated example, a sensor 428 (e.g., a hydrogen sulfide sensor, a viscometer, a bubble point sensor, etc.) is coupled to the first portion 412 of the housing 402. The example sensor 428 includes a bulkhead 430, which is disposed in the first fluid flow passageway 404. In some examples, the first fluid flow passageway 404 is in fluid communication with the sensor 430 and/or a fluid container (not shown).

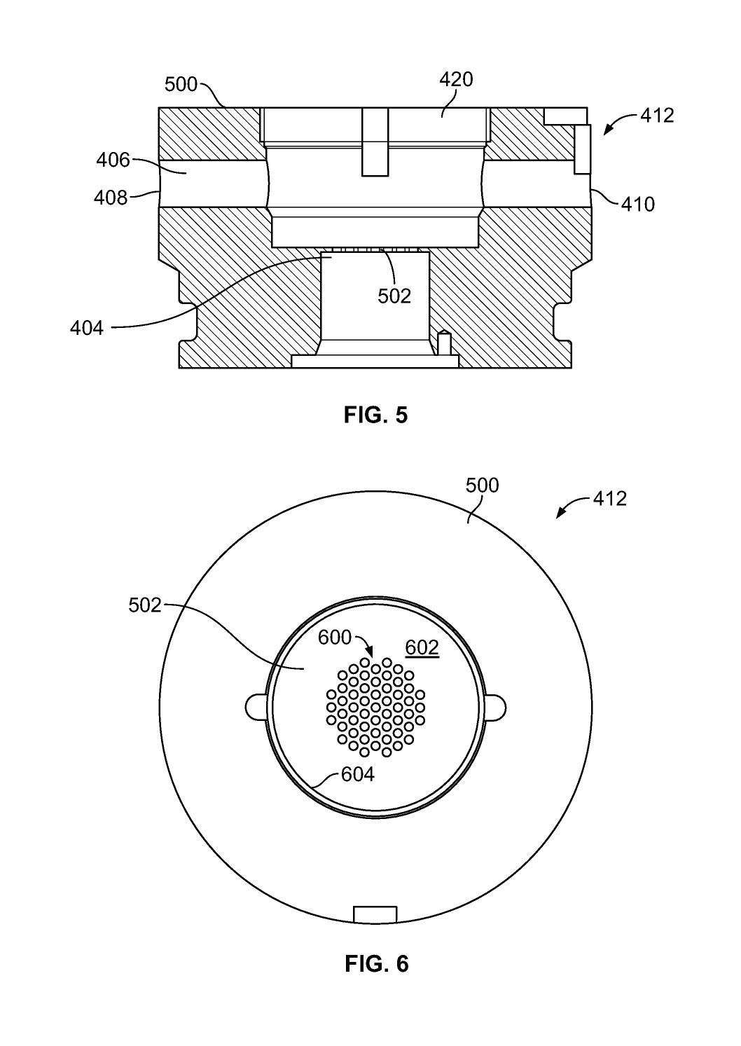

FIG. 5 is a cross-sectional view of the first portion 412 of the example housing 402. The first portion 412 of the example housing 402 defines the first fluid flow passageway 404 and the inlet 408 and the outlet 410 of the second fluid flow passageway 406. The example first portion 412 of the housing 402 defines the bore or cavity 420. In the illustrated example, the bore 420 and the first fluid flow passageway 404 are substantially concentric, and the bore 420 extends from an exterior surface 500 of the first portion 412 of the housing 402 through the second fluid flow passageway 406.

In the illustrated example, a first plate or partition 502 is positioned along the bore 420 between the first fluid flow passageway 404 and the second fluid flow passageway 406. The example first partition 502 is substantially planar and oriented substantially parallel to the section 418 of the second fluid flow passageway 406. In the illustrated example, the first partition 502 and the housing 402 are integrally formed. In some examples, the first partition 502 is a separate component that is coupled to the first portion 412 of the housing 402. In other examples, the example apparatus 400 does not include the first partition 502.

FIG. 6 is a top view of the first portion 412 of the example housing 402. In the illustrated example, the first partition 502 includes a plurality of apertures or perforations 600 extending through the first partition 502. In the illustrated example, the first partition 502 includes 55 circular perforations 600 having a diameter of about 1 millimeter. However, the above-noted shape, dimension, and number of perforations are merely examples and, thus, other shapes, dimensions and/or number of perforations may be used without departing from the scope of this disclosure. In some examples, the first partition 502 includes one aperture. In the illustrated example, the perforations 600 are positioned (e.g., concentrated) about a center of the first partition 502 over the first fluid flow passageway 404 in the orientation of FIG. 6, and the first partition 502 includes a surface 602 between the perforations 600 and a wall 604 of the bore 420. In some examples, the surface 602 includes a recess or groove to receive a seal (e.g., an o-ring), which provides a fluid seal surrounding or circumscribing the perforations 600 and, thus, the first fluid flow passageway 404.

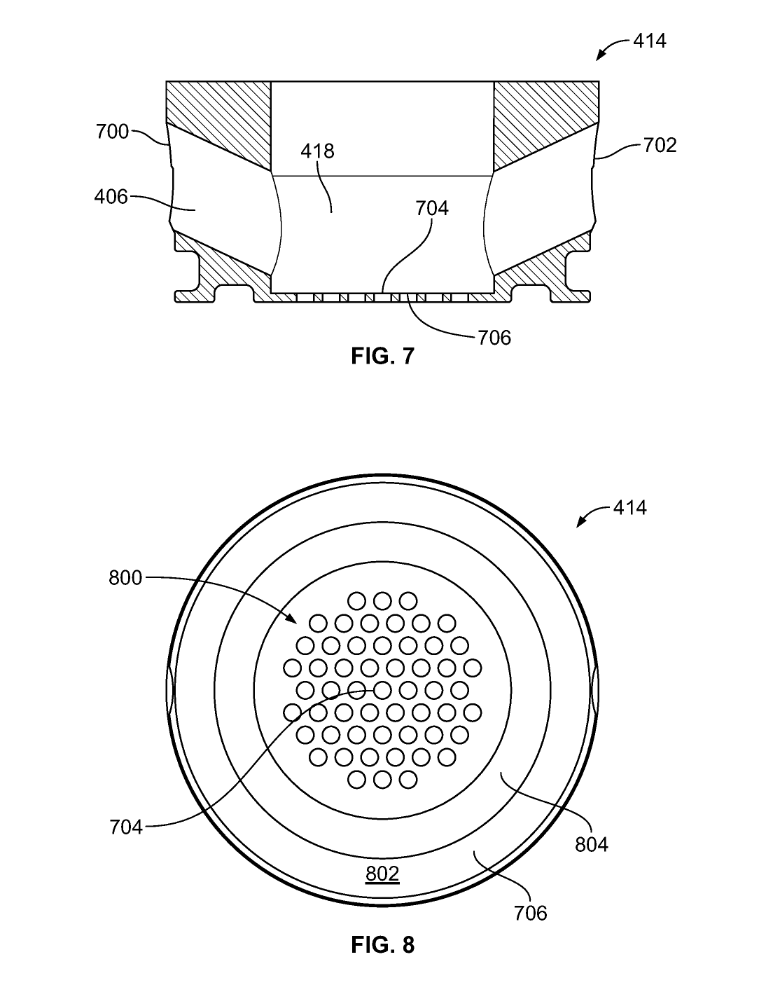

FIG. 7 is a cross-sectional view of the second portion 414 of the example housing 402. In the illustrated example, the second portion 414 defines a portion of the second fluid flow passageway 406 including the section 418. The second portion 414 of the example housing 402 is disposed in the bore 420 of the first portion 412 of the housing 402 and oriented such that the section 418 of the second fluid flow passageway 406 is adjacent the first fluid flow passageway 404. In the illustrated example, the second portion 414 of the housing 402 includes a first port 700 and a second port 702. The fluid mixture flows into the section 418 via the first port 700, and a portion of the fluid mixture flows out of the section 418 via the second port 702. The example section 418 includes an inlet 704 to the first fluid flow passageway 404.

In the illustrated example, the inlet 704 to the first fluid flow passageway 404 is defined by a substantially planar second plate or partition 706. When the second portion 414 is coupled to the first portion 412, the second partition 706 is substantially parallel to the first partition 502, and the filter 416 is held between the first partition 502 and the second partition 706 over the first fluid flow passageway 404. In the illustrated example, the example second partition 706 and the second portion 414 of the example housing 402 are integrally formed. In some examples, the second partition 706 is a separate component that is coupled to the second portion 414 of the housing 402. In other examples, the example apparatus 400 does not include the second partition 706.

FIG. 8 is a bottom view of the second portion 414 of the example housing 402. The example second partition 706 includes a plurality of apertures or perforations 800 positioned (e.g., concentrated) about a center of the second partition 706. The example perforations 800 extend through the second partition 706 (i.e., from the section 418 to an exterior surface 802 of the second partition 706). In the illustrated example, the second partition 706 includes 55 circular perforations 800 having a diameter of about 1 millimeter. However, the above-noted shape, dimension and number of perforations are merely examples and, thus, other shapes, dimensions and/or numbers of perforations may be used without departing from the scope of this disclosure. In the illustrated example, the exterior surface 802 of the second partition 706 includes a recess or groove 804 to receive the seal 426 (e.g., an o-ring), which provides a fluid seal surrounding or circumscribing the inlet 704 and, thus, the first fluid flow passageway 404.

During operation, formation fluid flowing through a flowline of a downhole tool (e.g., one of the example downhole tools of FIGS. 1-3) flows through the second fluid flow passageway 406, including the section 418. The formation fluid may be a mixture of liquids, gases, and/or particulates. As the formation fluid flows through the section 418, the formation fluid flows along the second partition 706 and the surface (FIGS. 9-14) of the filter 416. A pressure of the second fluid flow passageway 406 is greater than a pressure of the first fluid flow passageway 404 to cause a fluid (e.g., a hydrocarbon phase, a gas, etc.) of the formation fluid to pass through the filter 416 while substantially preventing other fluids and/or particulates of the formation fluid from passing through the filter 416, thereby separating the fluid from the formation fluid. The fluid may then be analyzed and/or stored via the sensor 428 and/or a fluid container. The other fluids and/or the particulates of the formation fluid flow out of the section 418 and return to the flowline of the downhole tool via the outlet 410 of the second fluid flow passageway 406.

FIGS. 9-14 illustrate example filters disclosed herein. For the purpose of simplicity, a portion of the first partition 502 and/or the second partition 706 is shown in FIGS. 9 and 11-13. In FIG. 10, the second partition 706 is not shown.

FIGS. 9-10 illustrate an example filter 900 in accordance with the teachings of this disclosure. FIG. 9 is a cross-sectional view of the example filter 900. The example filter 900 includes a porous, pliable sheet 902 (e.g., a PDMS membrane, a PTFE membrane, etc.) and a support or brace 904 coupled to a surface 905 of the sheet 902. In some examples, the sheet 902 has a thickness of about 0.1 millimeters to about 0.25 millimeters, and the support 904 has a thickness of 0.1 millimeters to about 0.5 millimeters. However, the above-noted dimensions are merely examples and, thus, other dimensions may be used without departing from the scope of this disclosure. The example support 904 is coupled to the sheet 902 via a chemical fastener 906 such as, for example, an epoxy adhesive, PDMS glue, and/or any other suitable chemical fastener. In some examples, the sheet 902 is held taut via the support 904.

In the illustrated example, the second partition 706 contacts the support 904, and the first partition 502 contacts the sheet 902 to hold the example filter 900 across the inlet 704. Thus, when the fluid mixture flows through the section 418, the fluid mixture flows along the surface 905 of the sheet 902. The example first partition 502 substantially prevents deformation of the sheet 902 toward the first fluid flow passageway 404 (i.e., downward in the orientation of FIG. 9) where the first partition 502 contacts the sheet 902.

FIG. 10 is a top view of the example filter 900 of FIG. 9. In the illustrated example, the sheet 902 is substantially circular, and the support 904 is an annular shim (e.g., a washer). However, the above-noted shapes are merely examples and, thus, other shapes may be used without departing from the scope of this disclosure. In the illustrated example, an outer diameter of the support 904 is approximately equal to a diameter of the sheet 902, and an inner diameter of the support 904 is less than an inner diameter of the seal 426. In some examples, the diameter of the sheet 902 and the outer diameter of the support 904 are about 5 millimeters to about 100 millimeters. However, the above-noted dimensions are merely examples and, thus, other dimensions may be used without departing from the scope of this disclosure. In some examples, the support 904 is a plate or shim including a plurality of apertures or perforations defining fluid flow paths of the filter. In the illustrated example, the filter 900 is oriented such that the seal 426 contacts the support 904 and the housing 402 to provide a fluid seal surrounding the first fluid flow passageway 404. Thus, in some examples, the support 904 provides a seat for the seal 426, and an inner diameter of the example support 904 defines a fluid flow path of the filter 900.

FIG. 11 is a cross-sectional view illustrating the example filter 900 held by the housing 402 in an inverted orientation relative to the orientation of the filter 900 illustrated in FIG. 9. Thus, in the illustrated example of FIG. 11, the filter 900 is oriented such that the second partition 706 contacts the sheet 902, and the first partition 502 contacts the support 904. In the illustrated example, the seal 426 contacts the sheet 900 and the housing 402 to provide a fluid seal surrounding the first fluid flow passageway 404. The example second partition 706 substantially prevents deformation of the sheet 902 toward the second fluid flow passageway 406 (i.e., upward in the orientation of FIG. 11) where the second partition 706 contacts the sheet 902.

FIG. 12 illustrates another example filter 1200 disclosed herein, which may be used to implement the example apparatus 400 of FIG. 4. The example filter 1200 includes a porous, pliable sheet 1202 including a first surface 1204 and a second surface 1206. A first support 1208 is coupled to the first surface 1204 of the sheet 1202, and a second support 1210 is coupled to the second surface 1206 of sheet 1202. In some examples, the sheet 1202 has a thickness of about 0.1 millimeters to about 0.25 millimeters, and the first support 1208 and the second support 1210 each has a thickness of about 0.1 millimeters to about 0.5 millimeters. However, the above-noted dimensions are merely examples and, thus, other dimensions may be used without departing from the scope of this disclosure. The example first support 1208 and the example second support 1210 are coupled to the sheet 1202 via a chemical fastener 1212 such as, for example, an epoxy adhesive, PDMS glue, and/or any other suitable chemical fastener. In some examples, the sheet 1202 is held taut via one or both of the example first support 1208 and the example second support 1210. In the illustrated example, the second partition 706 contacts first support 1208, and the first partition 502 contacts the second support 1210.

In the illustrated example, the sheet 1202 is substantially circular, and the first support 1208 and the second support 1210 are annular shims (e.g., washers). However, the above-noted shapes are merely examples and, thus, other shapes may be used without departing from the scope of this disclosure. In some examples, one or both of the first and second supports 1208 and 1210 includes a plurality of apertures or perforations. In the illustrated example, outer diameters of the first and second supports 1208 and 1210 are approximately equal to a diameter of the sheet 1202, and the inner diameters of the first and second supports are less than the inner diameter of the seal 426. In some examples, the outer diameters of the supports 1208 and 1210 and the diameter of the sheet 1202 are about 5 millimeters to about 100 millimeters. However, the above-noted dimensions are merely examples and, thus, other dimensions may be used without departing from the scope of this disclosure. In the illustrated example, the seal 426 contacts the first support 1208 and the second portion 414 of the housing 402 to provide a fluid seal surrounding the first fluid flow passageway 404, and the inner diameters of the example first and second supports 1208 and 1210 define a fluid flow path of the filter 1200.

FIG. 13 is a cross-sectional view of another example filter 1300 disclosed herein. The example filter 1300 includes a porous, pliable sheet 1302 including a first surface 1304 and a second surface 1306. A first support 1308 is coupled to the first surface 1304 of the sheet 1302, and a second support 1310 is coupled to the second surface 1306 of sheet 1302. In some examples, the sheet 1302 has a thickness of about 0.1 millimeters to about 0.25 millimeters, and the first support 1308 and the second support 1310 each has a thickness of about 0.1 millimeters to about 0.5 millimeters. However, the above-noted dimensions are merely examples and, thus, other dimensions may be used without departing from the scope of this disclosure. The example first support 1308 and the example second support 1310 are coupled to the sheet 1302 via a chemical fastener 1312 such as, for example, an epoxy adhesive, PDMS glue, and/or any other suitable chemical fastener. In some examples, the sheet 1302 is held taut via the example first support 1308 and/or the example second support 1310. In the illustrated example, the second partition 706 contacts the first support 1308, and the first partition 502 contacts the second support 1310.

In the illustrated example, the sheet 1302 is substantially circular, and the first support 1308 and the second support 1310 are annular shims (e.g., washers). However, the above-noted shapes are merely examples and, thus, other shapes may be used without departing from the scope of this disclosure. In some examples, the first support 1308 and/or the second support 1310 include a plurality of apertures or perforations. In the illustrated example, outer diameters of the first support 1308 and the second support 1310 are greater than a diameter of the sheet 1302, and inner diameters of the first support 1308 and the second support 1310 are less than the diameter of the sheet 1302. A third support 1314 surrounds or circumscribes the sheet 1302 and is disposed between and coupled to the first support 1308 and/or the second support 1310. In the illustrated example, a thickness of the third support 1314 is about equal to the thickness of the sheet 1302 (e.g., between about 0.1 millimeters and 0.5 millimeters). In the illustrated example, the seal 426 contacts the first support 1308 and the housing 402 to provide a fluid seal surrounding the first fluid flow passageway 404, and the inner diameters of the first support 1308 and the second support 1310 define a flow path of the filter 1300.

FIG. 14 is a cross-sectional view of yet another example filter 1400 disclosed herein, which may be used to implement the example apparatus 400 of FIG. 4. The example filter 1400 includes a porous, pliable sheet 1402 including a first surface 1404 and a second surface 1406. A first plate or support 1408 is coupled to the first surface 1404 of the sheet 1402, and a second plate or support 1410 is coupled to the second surface 1406 of sheet 1402. In some examples, the sheet 1402 has a thickness between about 0.1 millimeters and about 0.25 millimeters, and the first support 1408 and the second support 1410 each has a thickness between about 0.1 millimeters and about 0.5 millimeters. However, the above-noted dimensions are merely examples and, thus, other dimensions may be used without departing from the scope of this disclosure. The example first support 1408 and the example second support 1410 are coupled to the sheet 1402 via a chemical faster 1412 such as, for example, an epoxy adhesive, PDMS glue, and/or any other suitable chemical fastener. In some examples, the sheet 1402 is held taut via the example first support 1408 and/or the example second support 1410.

In the illustrated example, the sheet 1402, the first support 1408 and the second support 1410 are substantially circular. However, the above-noted shape is merely an example and, thus, other shapes may be used without departing from the scope of this disclosure. In the illustrated example, outer diameters of the supports 1408 and 1410 are approximately equal to a diameter of the sheet 1402. In some examples, the outer diameters of the supports 1408 and 1410 and the diameter of the sheet 1402 are about 5 millimeters to about 100 millimeters. However, the above-noted dimensions are merely examples and, thus, other dimensions may be used without departing from the scope of this disclosure.

The example first support 1408 and the example second support 1410 each includes a plurality of apertures 1414, 1416, 1418, 1420, 1422 and 1424 positioned (i.e., concentrated) about a center of the first support 1408 and the second support 1410. In some examples implemented using the example filter 1400 of FIG. 14, the first portion 412 and/or the second portion 414 of the example housing 402 do not include the first partition 502 and/or the second partition 706, respectively. The example supports 1408 and 1410 substantially prevent deformation of the sheet 1402 more than a distance corresponding to a thickness of the chemical fastener 1412 between the respective support 1408, 1410 and the sheet 1402 toward the first fluid flow passageway 404 (i.e., downward in the orientation of FIG. 14) and/or the second fluid flow passageway 406 (i.e., upward in the orientation of FIG. 14), respectively, where the first support 1408 and/or the second support 1410 contact the sheet 1402 during operation. In the illustrated example, the seal 426 contacts the first support 1408 and the second portion 414 of the housing 402 to provide a fluid seal surrounding the first fluid flow passageway 404, and the apertures 1414, 1416, 1418, 1420, 1422 and 1424 of the first support 1408 and the second support 1410 define fluid flow paths of the filter 1400.

Although a few example embodiments have been described in detail above, those skilled in the art will readily appreciate that many modifications are possible in the example embodiments without materially departing from fluid filters. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. An apparatus, comprising:
a filter including a pliable sheet and a support coupled to the sheet, the support defining one or more fluid flow paths of the filter;
a first portion of a housing coupled to a second portion of the housing to hold the filter over a first fluid flow passageway and adjacent a second fluid flow passageway such that fluid is to flow along a surface of the filter as the fluid flows through the second fluid flow passageway; and
a seal positioned between the support and the housing to provide a fluid seal surrounding the one or more fluid flow paths of the filter.

2. The apparatus of claim 1 wherein the filter is positioned across an inlet of the first fluid flow passageway.

3. The apparatus of claim 1 wherein the first portion of the housing holds the filter via a perforated partition.

4. The apparatus of claim 3 wherein the perforated partition substantially prevents deformation of the sheet where the partition contacts the sheet.

5. The apparatus of claim 1 wherein the second portion of the housing holds the filter via a perforated partition.

6. The apparatus of claim 1 wherein the support is a perforated plate.

7. The apparatus of claim 1 wherein the support is coupled to a first surface of the sheet and another support is coupled to a second surface of the sheet.

8. The apparatus of claim 1 wherein the second fluid flow passageway is in fluid communication with a flowline of a downhole tool.

9. The apparatus of claim 1 wherein the first fluid flow passageway is in fluid communication with a sensor.

10. An apparatus, comprising:
a pliable filter;
a brace coupled to the filter;
a first portion of a housing coupled to a second portion of a housing to hold the filter across an inlet of a first fluid flow passageway, the first fluid flow passageway in fluid communication with a second fluid flow passageway via the inlet; and
a seal disposed between the brace and the housing and surrounding the inlet.

11. The apparatus of claim 10 wherein the filter is oriented to cause fluid to flow along a surface of the filter as the fluid flows through the second fluid flow passageway.

12. The apparatus of claim 10 wherein the first portion of the housing holds the filter via a perforated plate.

13. The apparatus of claim 12 wherein the perforated plate substantially prevents deformation of the filter where the plate contacts the sheet.

14. The apparatus of claim 10 wherein the second portion of the housing holds the filter via a perforated plate.

15. The apparatus of claim 10 wherein the brace is a perforated plate.

16. The apparatus of claim 10 wherein the brace is coupled to a first surface of the filter and another brace is coupled to a second surface of the filter.

17. The apparatus of claim 10 wherein the second fluid flow passageway is in fluid communication with a flowline of a downhole tool.

18. The apparatus of claim 10 wherein the first fluid flow passageway is in fluid communication with a sensor.

19. An apparatus, comprising:
means for supporting coupled to means for filtering;
first means for holding defining a first fluid flow passageway, the first means for holding coupled to second means for holding to hold the means for filtering across an inlet of the first fluid flow passageway, the first fluid flow passageway in fluid communication with a second fluid flow passageway via the inlet; and
means for sealing disposed between the means for supporting and one of the first means for holding or the second means for holding and surrounding the inlet.

20. The apparatus of claim 19 wherein the means for filtering is oriented to cause fluid to flow along a surface of the means for filtering as the fluid flows through the second fluid flow passageway.
